(19) United States
(12) Patent Application Publication
(10) Pub. No.: US 2014/0325010 A1
(43) Pub. Date: Oct. 30, 2014

(54) ELECTRONIC APPARATUS AND LOG INFORMATION TRANSFER METHOD

(71) Applicant: KYOCERA Document Solutions Inc., Osaka (JP)

(72) Inventor: Koji Fujii, Osaka-shi (JP)

(73) Assignee: KYOCERA Document Solutions Inc., Osaka (JP)

(21) Appl. No.: 14/260,848

(22) Filed: Apr. 24, 2014

(30) Foreign Application Priority Data
Apr. 24, 2013 (JP) 2013-091508

(51) Int. Cl. H04L 12/58

(52) U.S. Cl. CPC H04L 51/26
USPC 709/207

(57) ABSTRACT

An electronic apparatus includes a communication unit, a storage capable of storing information for a predetermined storage capacity, a logging controller, a log transferer for causing the communication unit to successively transmit log information stored in the storage to an external apparatus and deleting the transmitted log information from the storage, and a remaining amount detector for detecting a remaining storage capacity. A first priority order or a second priority order lower than the first priority order is assigned to each of the plurality of pieces of log information according to importance. The logging controller stores the log information assigned with the first and second priority orders in the storage if the remaining storage capacity is not less than a predetermined reference capacity and stores the log information assigned with the first priority order in the storage if the remaining storage capacity is less than the reference capacity.

### INCORPORATION BY REFERENCE

This application is based on Japanese Patent Application Serial No. 2013-091508 filed with the Japan Patent Office on Apr. 24, 2013, the contents of which are hereby incorporated by reference.

### BACKGROUND

The present disclosure relates to an electronic apparatus communicable with an external apparatus and particularly to a technique for transferring log information to an external apparatus.

Conventionally, so-called logging of storing various pieces of information on an electronic apparatus in a storage device such as a memory or a hard disk according to the passage of time has been performed in the electronic apparatus such as an image processing apparatus or an information processing apparatus. The information on the electronic apparatus includes information on the operation and state of each operating unit included in the electronic apparatus, information indicating detection values of sensors included in the electronic apparatus, information on abnormalities having occurred in the electronic apparatus or the like. The information stored according to the passage of time is known as log information.

The log information is useful in specifying a cause when an abnormality occurs in the electronic apparatus. Specifically, the log information is used to analyze the log information before the occurrence of the abnormality such as by being displayed on a liquid crystal display of the electronic apparatus or printed if the electronic apparatus is an image forming apparatus. This enables the operation of the electronic apparatus relating to the occurrence of the abnormality to be grasped and a background or a cause of the occurrence of the abnormality to be known.

However, due to the occurrence of an abnormality in the electronic apparatus, it may become impossible to access the storage device in the electronic apparatus storing the log information. In preparation for such a situation, it has been a conventional practice to transfer log information to an external apparatus such as a personal computer, utilizing a buffer transfer technique. That is, the log information is stored also in a storage device such as a RAM called a buffer according to the passage of time. Separately from a process of storing the log information in the buffer, a process of successively reading the log information stored in the buffer, transferring it to the external apparatus and deleting the transferred log information from the buffer is performed.

However, a state where new log information is written in the buffer without the log information being read from the buffer may continue, for example, due to a high communication load of a network such as a LAN (Local Area Network) used for communication between the electronic apparatus and the external apparatus or the like. This makes a free storage capacity of the buffer insufficient, causing a possibility that the log information cannot be stored in the buffer. As a result, log information having a high importance such as information on abnormalities having occurred in the electronic apparatus cannot be stored in the buffer and a log having a high importance may not be transferred to the external apparatus.

The present disclosure aims to reduce a possibility that log information having a high importance is not transferred to an external apparatus in an electronic apparatus communicable with the external apparatus.

### SUMMARY

An electronic apparatus according to the present disclosure is an electronic apparatus communicable with an external apparatus and includes a communication unit, a storage, a logging controller, a log transferer and a remaining amount detector. The communication unit transmits information to the external apparatus. The storage is capable of storing information for a predetermined storage capacity. The logging controller performs a logging process of storing a plurality of pieces of log information on the electronic apparatus in the storage. The log transferer performs a transfer process of causing the communication unit to successively transmit the plurality of pieces of log information stored in the storage to the external apparatus and deleting the transmitted log information from the storage. The remaining amount detector detects a remaining storage capacity indicating a storage capacity, in which no information is stored, out of the predetermined storage capacity. A first priority order or a second priority order lower than the first priority order is assigned to each of the plurality of pieces of log information according to the importance of the information expressed by each piece of log information. In the logging process, the logging controller stores the log information assigned with the first and second priority orders in the storage out of the plurality of pieces of log information if the remaining storage capacity detected by the remaining amount detector is not less than a predetermined reference capacity and stores the log information assigned with the first priority order in the storage out of the plurality of pieces of log information if the remaining storage capacity detected by the remaining amount detector is less than the reference capacity.

These and other objects, features and advantages of the present disclosure will become more apparent upon reading the following detailed description along with the accompanying drawings.

### BRIEF DESCRIPTION OF THE DRAWINGS

FIG. 1 is a schematic configuration diagram of a complex machine according to one embodiment of an electronic apparatus according to the present disclosure,

FIG. 2 is a block diagram showing an example of the electrical configuration of the complex machine,

FIG. 3 is a table showing an example of a relationship of log information and priority order,

FIG. 4 is a table showing an example of a relationship of reference priority order associated with a remaining storage capacity and priority order associated with log information, and

FIG. 5 is a flow chart showing operations of a login process by a logging controller and a transfer process by a log transferrer.

### DETAILED DESCRIPTION

Hereinafter, an embodiment of the present disclosure is described based on the drawings. Note that components denoted by the same reference signs in each drawing are the same components. Thus, repeated description of the components denoted by the same reference signs is omitted as appropriate unless a change or the like is described.

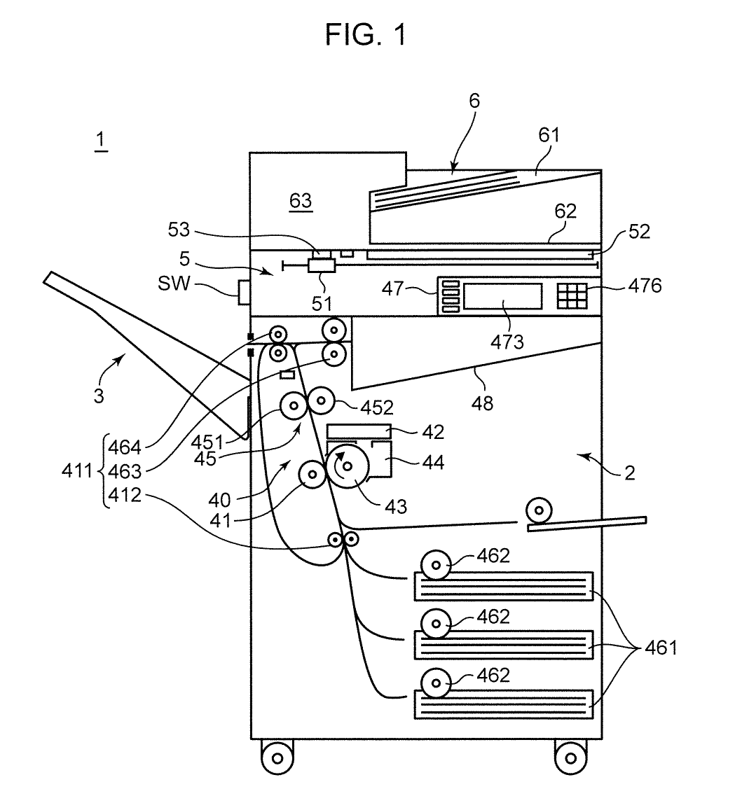

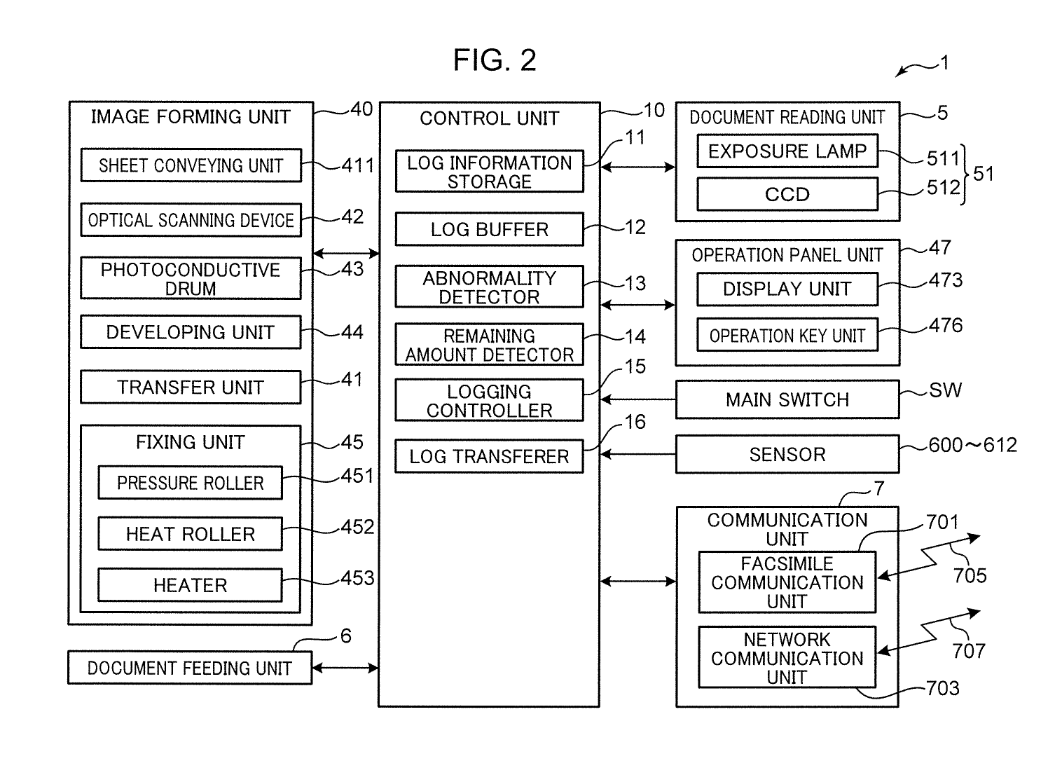

FIG. 1 is a schematic configuration diagram of a complex machine 1 according to one embodiment of an electronic apparatus according to the present disclosure. FIG. 2 is a block diagram showing an example of the electrical configuration of the complex machine 1. The complex machine 1 has functions of a scanner, a copier, a printer, a facsimile machine and the like.

As shown in FIG. 1, the complex machine 1 includes an operation panel unit 47 (operation unit), a document reading unit 5 (operation unit), a main switch SW (operation unit), a document feeding unit 6 (operation unit), a stack tray 3 and a main body 2.

The operation panel unit 47 includes a display unit 473 and an operation key unit 476. The display unit 473 is, for example, a liquid crystal display having a touch panel function or the like. The operation key unit 476 includes various keys and switches such as a start key used to enter an image formation instruction by a user and a numerical keypad used to enter the number of print copies and the like.

The document reading unit 5 includes a scanner unit 51, a document platen 52 formed of a transparent material such as glass and a document reading slit 53. As shown in FIG. 2, the scanner unit 51 includes a CCD (Charge Coupled Device) 512, an exposure lamp 511 and the like. The scanner unit 51 is configured to be movable by an unillustrated driver. For example, at the time of reading a document placed on the document platen 52, the scanner unit 51 is moved along a document surface at a position facing the document platen 52 and outputs obtained image data to a control unit 10 to be described later while scanning a document image. Further, at the time of reading, for example, a document fed by the document feeding unit 6, the scanner unit 51 is moved to a position facing the document reading slit 53. Then, the scanner unit 51 obtains an image of the document in synchronization with a conveying movement of the document by the document feeding unit 6 via the document reading slit 53 and outputs obtained image data to the control unit 10 to be described later. Sensors for detecting information on the operation of the document reading unit 5 are mounted in the document reading unit 5. These sensors include, for example, a sensor 600 (FIG. 2) for detecting a jam of a document and the number of read documents, and the like.

The main switch SW is a switch for turning on (power supply) and off (cut off power supply) of the entire complex machine 1. Note that the main switch SW is not always necessary and power may be supplied to the entire complex machine 1 when the complex machine 1 is connected to a commercial power supply.

The document feeding unit 6 includes a document placing portion 61 on which documents are to be placed, a document discharging portion 62 for discharging a document having an image read, and a document conveying mechanism 63. The document conveying mechanism 63 picks up the documents placed on the document placing portion 61 one by one and conveys them to a position facing the document reading slit 53 and, then, discharges the documents to the document discharging portion 62. Sensors for detecting information on the operation of the document feeding unit 6 are mounted in the document feeding unit 6. These sensors include, for example, a sensor 601 (FIG. 2) for detecting a jam of a document and the number of picked-up documents, and the like.

The main body 2 includes a plurality of sheet cassettes 461, a plurality of feed rollers 462 (operation unit) for picking up sheets one by one from the corresponding sheet cassettes 461 and conveying them to an image forming unit 40, the image forming unit 40 for forming an image on a sheet conveyed from the sheet cassette 461, a communication unit 7 (operation unit, FIG. 2) and the control unit 10 (FIG. 2). Sensors for detecting information on the operation of the feed rollers 462 are mounted around the feed rollers 462. These sensors include, for example, a sensor 602 (FIG. 2) for detecting a jam of a sheet and the number of picked-up sheets, and the like.

The image forming unit 40 includes a sheet conveying unit 411 (operation unit), an optical scanning device 42 (operation unit), a photoconductive drum 43 (operation unit), a developing unit 44 (operation unit), a transfer unit 41 (operation unit) and a fixing unit 45 (operation unit).

The sheet conveying unit 411 includes conveyor rollers 412 for feeding a sheet conveyed by the feed roller 462 to the photoconductive drum 43, conveyor rollers 463, 464 for conveying the sheet to the stack tray 3 or a discharge tray 48 and the like. Sensors for detecting information on the operation of the sheet conveying unit 411 are mounted in the sheet conveying unit 411. These sensors include, for example, a sensor 603 (FIG. 2) for detecting a jam of a sheet and the number of picked-up sheets, and the like.

The optical scanning device 42 exposes the photoconductive drum 43 to light by outputting laser light based on image data output from the control unit 10. In this way, the optical scanning device 42 forms an electrostatic latent image on the photoconductive drum 43. The developing unit 44 supplies toner stored in an unillustrated toner cartridge to the electrostatic latent image on the photoconductive drum 43. In this way, the developing unit 44 develops the electrostatic latent image and forms a toner image on the photoconductive drum 43. The transfer unit 41 transfers the toner image on the photoconductive drum 43 to a sheet.

Sensors for detecting information on the operation of the photoconductive drum 43 are mounted around the photoconductive drum 43. These sensors include a sensor 604 for detecting a surface potential of the photoconductive drum 43, a sensor 605 for detecting a temperature of the photoconductive drum 43, and the like. Sensors for detecting information on the operation of the optical scanning device 42 are mounted in the optical scanning device 42. These sensors include a sensor 606 (FIG. 2) for detecting a voltage (exposure voltage) applied at the time of exposure, and the like. Sensors for detecting information on the operation of the developing unit 44 are mounted in the developing unit 44. These sensors includes a sensor 607 (FIG. 2) for detecting an electrostatic voltage applied at the time of developing an electrostatic latent image, a sensor 608 for detecting a remaining amount of the toner stored in the toner cartridge, and the like. Sensors for detecting information on the operation of the transfer unit 41 are mounted in the transfer unit 41. These sensors include a sensor 609 (FIG. 2) for detecting a voltage (pressure voltage) of a pressing portion for pressing when the toner image is transferred to the sheet, and the like.

The fixing unit 45 fixes a toner image to a sheet by heating the sheet having the toner image transferred thereto. The fixing unit 45 includes a heat roller 452 for melting the toner image formed on the sheet, a pressure roller 451 for conveying the sheet while pressing the sheet between the heat roller 452 and the pressure roller 451, and a heater 453 (FIG. 2) for heating the heat roller 452. The heater 453 is arranged in the heat roller 452. The heater 453 heats the sheet nipped between the heat roller 452 and the pressure roller 451 by heating the heat roller 452. Sensors for detecting information on the operation of the fixing unit 45 are mounted in the fixing unit 45. These sensors includes a sensor 610 (FIG. 2) for detecting a temperature (fixing temperature) of the heat roller 452 and the heater 453, a sensor 611 (FIG. 2) for detecting a pressure value of the pressure roller 451, and the like.

The communication unit 7 includes a facsimile communication unit 701 and a network communication unit 703 as shown in FIG. 2. The facsimile communication unit 701 includes an NCU (Network Control Unit) for controlling a telephone line connection with a destination facsimile machine and a modulation/demodulation circuit for modulating/demodulating a signal for facsimile communication such as an image signal. The facsimile communication unit 701 is connected to a telephone line 705. The network communication unit 703 is a communication interface circuit for carrying out communication with external apparatuses such as personal computers connected via a LAN (Local Area Network) 707. Sensors for detecting information on the operation of the communication unit 7 are mounted in the communication unit 7. These sensors includes a sensor 612 (FIG. 2) for detecting the amount of information (data amount) transmitted and received to and from external apparatuses such as facsimile machines and personal computers, and the like.

The control unit 10 controls the operation of the entire complex machine 1. The control unit 10 includes, for example, a CPU (Central Processing Unit) for performing arithmetic processings, a nonvolatile memory such as an EEPROM (Electrically Erasable and Programmable Read Only Memory) storing a predetermined control program, a RAM (Random Access Memory) for temporarily storing data and peripheral circuits such as a clock circuit for measuring a current time.

The control unit 10 utilizes a part of a storage area of the nonvolatile memory as a log information storage 11 and a predetermined partial storage area (predetermined storage capacity) out of a storage area of the RAM as a log buffer 12 (storage). Further, the control unit 10 configures an abnormality detector 13, a remaining amount detector 14, a logging controller 15 and a log transferer 16 by executing the control program stored in the nonvolatile memory.

A plurality of pieces of the log information on the complex machine 1 are stored in the log information storage 11 and the log buffer 12 by the log controller 15 to be described later. The log information includes information corresponding to the operation of each operation unit such as the sheet conveying unit 411, the optical scanning device 42, the photoconductive drum 43, the developing unit 44, the transfer unit 41 and the fixing unit 45 included in the image forming unit 40, the document reading unit 5, the document feeding unit 6, the operation panel unit 47 and the feed rollers 462. For example, the log information includes information on abnormalities having occurred in each operation unit, information indicating operating states of each operation unit, detection values of the sensors such as the sensors 600 to 612 arranged in the operation units and the like.

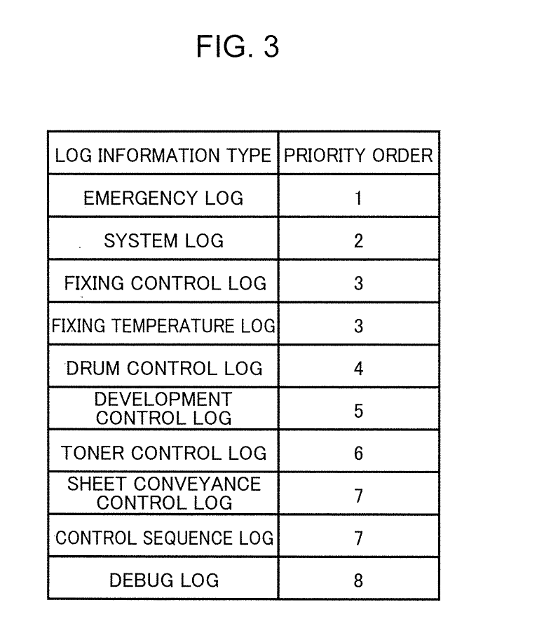

A priority order is assigned to each piece of the log information according to the importance of information indicated by each piece of the log information. FIG. 3 is a table showing an example of a relationship of log information and priority order. Specifically, the log information includes, for example, an emergency log, a system log, a fixing control log, a fixing temperature log, a drum control log, a development control log, a toner control log, a sheet conveyance control log, a control sequence log and a debug log as shown in FIG. 3.

The emergency log is information indicating operational abnormalities of each operation unit. For example, the operational abnormalities of each operation unit include abnormalities caused by a document jam or the simultaneous pick-up of a plurality of documents, abnormalities caused by a sheet jam or the simultaneous pick-up of a plurality of sheets, abnormalities of an exposure voltage value in the optical scanning device 42, abnormalities of an electrostatic voltage value in the developing unit 44, abnormalities of a transfer voltage value in the transfer unit 41, abnormalities of a fixing temperature value in the fixing unit 45, switch failures, toner shortage and the like. A highest priority order “1” indicating the log information having a highest importance is associated with the emergency log.

Note that an abnormality in the operation of each operation unit is detected as follows by the abnormality detector 13. For example, the abnormality detector 13 detects an abnormality when the detection value of each sensor 600 to 612 is not included in a predetermined range. Specifically, an abnormality is detected if the detection value such as the voltage value, the temperature value or the toner remaining amount detected by the sensor is outside the predetermined range. Further, the abnormality detector 13 detects an abnormality also when a jam of a document or a sheet is detected by the sensor.

The system log is information corresponding to the overall operation of the complex machine 1. The system log includes, for example, information indicating timings at which the main switch SW was turned on and off, i.e. timings at which the supply of power to the complex machine 1 is started and cut off, information indicating the start and end of an initial operation of each operation unit performed at the beginning of supplying power to each operation unit. A second highest priority order “2” indicating an importance next to the emergency log is associated with the system log.

The fixing control log is information corresponding to each operation of the fixing unit 45. The fixing control log includes, for example, information indicating start and end timings of each operation in the fixing unit 45 such as an operation of melting a toner image, a pressure value of the pressure roller 451 detected by the sensor 611, and the like. A third highest priority order “3” indicating an importance next to the system log is associated with the fixing control log.

The fixing temperature log is information indicating a value of the fixing temperature detected by the sensor 601, which value changes in a time-series manner during each operation in the fixing unit 45. Similarly to the fixing control log, the third highest priority order “3” indicating an importance next to the system log is associated with the fixing temperature log.

The drum control log is information corresponding to the operation of the photoconductive drum 43. The drum control log includes, for example, information indicating start and end timings of an operation of rotating the photoconductive drum 43, detection values such as a surface potential of the photoconductive drum 43 and a temperature of the photoconductive drum 43 detected by the sensors such as the sensors 604, 605, and the like. A fourth highest priority order “4” indicating an importance next to the fixing control log and the fixing temperature log is associated with the drum control log.

The development control log is information corresponding to each operation in the optical scanning device 42, the developing unit 44 and the transfer unit 41. The development control log includes, for example, information indicating start and end timings of each operation in the optical scanning device 42, the developing unit 44 and the transfer unit 41 such as an exposure operation in the optical scanning device 42, an operation of developing an electrostatic latent image in the developing unit 44 and a pressing operation to transfer a toner image to a sheet in the transfer unit 41. Further, the development control log includes a voltage value of an exposure voltage in the optical scanning device 42, a voltage value of an electrostatic voltage in the developing unit 44, a voltage value of a pressure voltage in the transfer unit 41 and the like detected by the sensors such as the sensors 606, 607 and 609. A fifth highest priority order “5” indicating an importance next to the drum control log is associated with the development control log.

The toner control log is information corresponding to a toner supply operation. The toner control log includes, for example, information indicating start and end timings of each of an operation of agitating the toner in the unillustrated toner cartridge and an operation of supplying the toner in the toner cartridge performed during an operation of developing an electrostatic latent image in the developing unit 44. Further, the toner control log includes a detection value of the remaining amount of the toner stored in the toner cartridge and the like detected by the sensors such as the sensor 608. A sixth highest priority order “6” indicating an importance next to the development control log is associated with the toner control log.

The sheet conveyance control log is information corresponding to the operation of the sheet conveying unit 411. The sheet conveyance control log includes, for example, information indicating start and end timings of an operation of driving the conveyor rollers 412, 463 and 464. Further, the sheet conveyance control log includes the number of sheets conveyed to the image forming unit 40 from the sheet cassettes 461, the number of sheets conveyed from the image forming unit 40 to the stack tray 3 or the discharge tray 48 detected by the sensors such as the sensors 602, 603. A seventh highest priority order “7” indicating an importance next to the toner control log is associated with the sheet conveyance control log.

The control sequence log is information corresponding to each operation in the document reading unit 5, the document feeding unit 6 and the communication unit 7 excluding each operation unit included in the image forming unit 40. The control sequence log includes, for example, information indicating start and end timings of the operations of the document reading unit 5, the document feeding unit 6 and the communication unit 7 such as a movement of the scanner unit 51 in the document reading unit 5, an operation of automatically feeding documents in the document feeding unit 6 and the transmission and reception of information to and from the external apparatus in the communication unit 7. Further, the control sequence log includes the number of documents read by the document reading unit 5, the number of documents fed by the document feeding unit 6 and the amount of information transmitted and received by the communication unit 7 detected by the sensors such as the sensors 600, 601 and 612 during the respective operations of the document reading unit 5, the document feeding unit 6 and the communication unit 7. Similarly to the sheet conveyance control log, the seventh highest priority order “7” indicating an importance next to the toner control log is associated with the control sequence log.

A debug output command for causing arbitrary information to be output at an arbitrary timing such as for the purpose of confirming the operation of the control program is built into the control program in advance by a developer. The debug log is the above arbitrary information to be output by executing the debug output command built into the control program at an arbitrary timing during the execution of the control program. A lowest priority order “8” indicating a lowest importance is associated with the debug log.

Note that the types of the log information and the orders of priority associated with the respective pieces of the log information are not limited to specific examples shown in FIG. 3.

Referring back to FIG. 2, the remaining amount detector 14 detects address information of a storage area where no information is stored out of the predetermined partial storage area of the RAM used as the log buffer 12. Then, the remaining amount detector 14 detects a remaining storage capacity indicating the amount of information storable in the storage area corresponding to the detected address information.

The logging controller 15 performs a logging process of storing the log information in the log information storage 11 and the log buffer 12. Specifically, in the logging process, the logging controller 15 refers to a reference priority order associated with the remaining storage amount and predetermined so as to become higher as the remaining storage capacity decreases and stores the log information corresponding to priority order(s) higher than the reference priority order corresponding to the remaining storage capacity detected by the remaining amount detector 14 in the log buffer 12 out of a plurality of pieces of the log information. Note that the logging process is described in detail later.

The log transferer 16 performs a transfer process. The transfer process is a process of causing the communication unit 7 to successively transmit a plurality of pieces of the log information stored in the log buffer 12 to the external apparatus and deleting the transmitted log information from the log buffer 12.

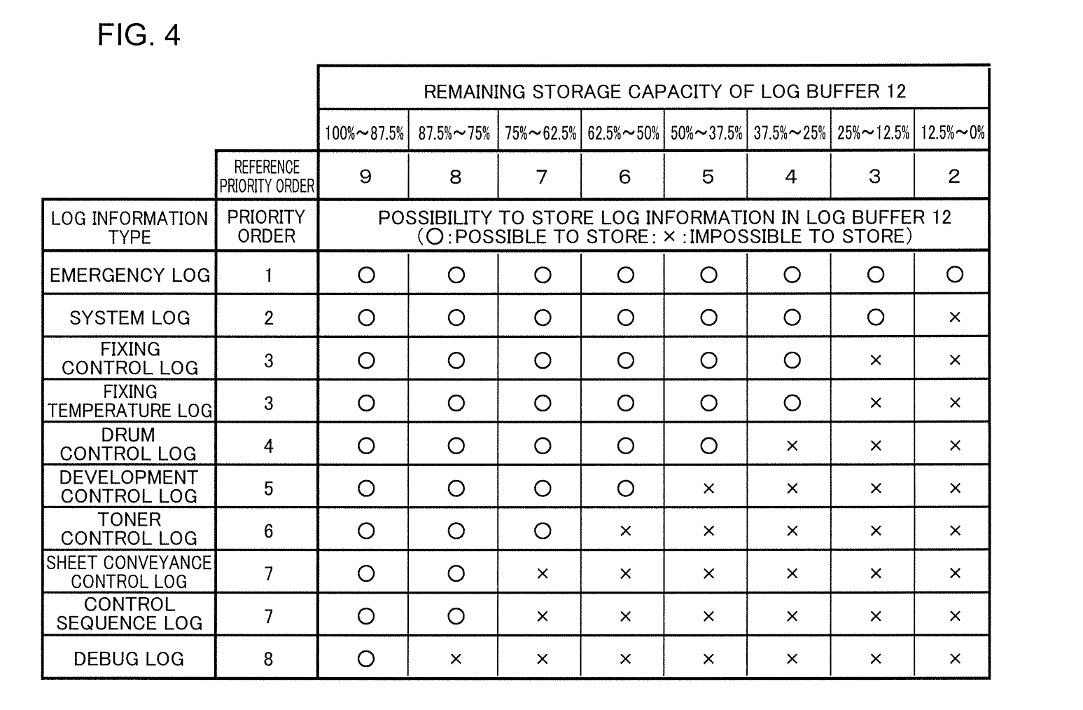

FIG. 4 is a table showing an example of a relationship of the reference priority order associated with the remaining storage capacity and the priority order associated with the log information. For example, as shown in FIG. 4, the reference priority order is associated with the remaining storage capacity detected by the remaining amount detector 14 and so predetermined as to become higher as the remaining storage capacity decreases. Specifically, a lowest reference priority order “9” is predetermined for a case where the remaining storage capacity is not more than 100%, but more than 87.5% of the amount of information storable in the predetermined partial storage area of the RAM used as the log buffer 12. The amount of information storable in the predetermined partial storage area of the RAM used as the log buffer 12 is referred to as the “storage capacity of the log buffer 12”.

Further, a reference priority order “8” higher than the reference priority order for the case where the remaining storage capacity is not more than 100%, but more than 87.5% of the storage capacity of the log buffer 12 is predetermined for a case where the remaining storage capacity is not more than 87.5%, but more than 75% of the storage capacity of the log buffer 12.

Similarly, reference priority orders “7”, “6”, “5”, “4”, “3” and “2” are predetermined in association with a case where the remaining storage capacity is not more than 75%, but more than 62.5% of the storage capacity of the log buffer 12, a case where the remaining storage capacity is not more than 62.5%, but more than 50% of the storage capacity of the log buffer 12, a case where the remaining storage capacity is not more than 50%, but more than 37.5% of the storage capacity of the log buffer 12, a case where the remaining storage capacity is not more than 37.5%, but more than 25% of the storage capacity of the log buffer 12, a case where the remaining storage capacity is not more than 25%, but more than 12.5% of the storage capacity of the log buffer 12 and a case where the remaining storage capacity is not more than 12.5% of the storage capacity of the log buffer 12. In this way, the reference priority order is so determined as to become higher as the remaining storage capacity decreases.

Note that the reference priority orders determined according to the remaining storage capacity detected by the remaining amount detector 14 are not limited to specific examples shown in FIG. 4.

For example, it is assumed that the remaining storage capacity detected by the remaining amount detector 14 is not more than 100%, but more than 87.5% of the storage capacity of the log buffer 12. In this case, in the logging process, the logging controller 15 stores the log information associated with the priority orders of “1” to “8” higher than the reference priority order “9” associated with the case where the remaining storage capacity is not more than 100%, but more than 87.5% of the storage capacity of the log buffer 12 in the log buffer 12. That is, the logging controller 15 stores the emergency log, the system log, the fixing control log, the fixing temperature log, the drum control log, the development control log, the toner control log, the sheet conveyance control log, the control sequence log and the debug log in the log buffer 12.

Further, due to a high communication load between the external apparatus and the complex machine 1 or the like, a state where a processing speed of the transfer process by the log transferer 16 is lower than that of the logging process by the logging controller 15 may continue. This may cause the remaining storage capacity detected by the remaining amount detector 14 to be decreased. It is, for example, assumed that the remaining storage capacity becomes not more than 87.5%, but more than 75% of the storage capacity of the log buffer 12 as a result of that. In this case, the logging controller 15 stores the log information associated with the priority orders “1” to “7” higher than the reference priority order “8” associated with the case where the remaining storage capacity is not more than 87.5%, but more than 75% of the storage capacity of the log buffer 12 in the log buffer 12 in the logging process. That is, the logging controller 15 stores the emergency log, the system log, the fixing control log, the fixing temperature log, the drum control log, the development control log, the toner control log, the sheet conveyance control log and the control sequence log in the log buffer 12, but does not store the debug log associated with the priority order “8” in the log buffer 12.

Similarly, if the remaining storage capacity is not more than 75%, but more than 62.5% of the storage capacity of the log buffer 12, the logging controller 15 stores the log information associated with the priority orders “1” to “6” higher than the reference priority order “7” associated with the remaining storage capacity in the log buffer 12 in the logging process. If the remaining storage capacity is not more than 62.5%, but more than 50% of the storage capacity of the log buffer 12, the logging controller 15 stores the log information associated with the priority orders “1” to “5” higher than the reference priority order “6” associated with the remaining storage capacity in the log buffer 12 in the logging process. If the remaining storage capacity is not more than 50%, but more than 37.5% of the storage capacity of the log buffer 12, the logging controller 15 stores the log information associated with the priority orders “1” to “4” higher than the reference priority order “5” associated with the remaining storage capacity in the log buffer 12 in the logging process.

Further, if the remaining storage capacity is not more than 37.5%, but more than 25% of the storage capacity of the log buffer 12, the logging controller 15 stores the log information associated with the priority orders “1” to “3” higher than the reference priority order “4” associated with the remaining storage capacity in the log buffer 12 in the logging process. If the remaining storage capacity is not more than 25%, but more than 12.5% of the storage capacity of the log buffer 12, the logging controller 15 stores the log information associated with the priority orders “1” to “2” higher than the reference priority order “3” associated with the remaining storage capacity in the log buffer 12 in the logging process. If the remaining storage capacity is not more than 12.5%, but more than 0% of the storage capacity of the log buffer 12, the logging controller 15 stores the log information associated with the priority order “1” higher than the reference priority order “2” associated with the remaining storage capacity in the log buffer 12 in the logging process.

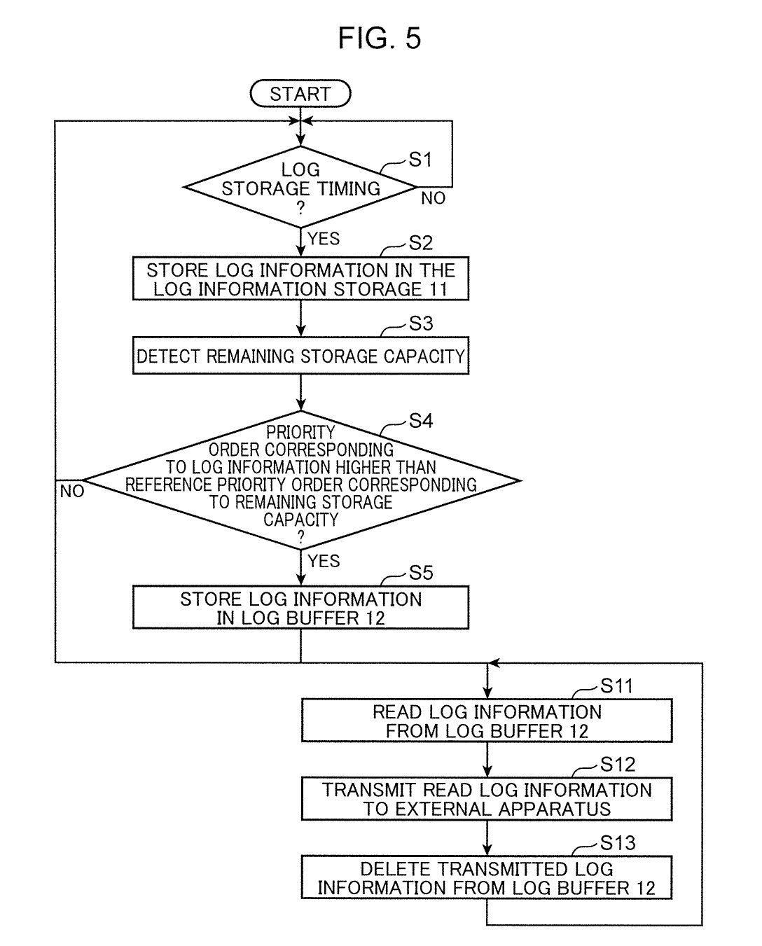

Next, the logging process by the logging controller 15 and the transfer process by the log transferer 16 are described using FIG. 5. FIG. 5 is a flow chart showing operations of the logging process by the logging controller 15 and the transfer process by the log transferer 16.

As shown in FIG. 5, when a timing at which each piece of the log information is stored is reached (S1; YES), the logging controller 15 starts the logging process. That is, the logging controller 15 stores the log information as a storage object in the log information storage 11 in association with the current time measured by the clock circuit (S2).

Further, the logging controller 15 causes the remaining amount detector 14 to detect the remaining storage capacity (S3). It is assumed that the priority order associated with the log information as the storage object is higher than the reference priority order associated with the remaining storage capacity detected by the remaining amount detector 14 as a result of that (S4; YES). In this case, the logging controller 15 stores the log information as the storage object in the log buffer 12 in association with the current time measured by the clock circuit (S5). After Step S5, processings in and after Step S1 are repeated.

Specifically, it is, for example, assumed that the remaining storage capacity detected in Step S3 is not more than 87.5%, but more than 75% of the storage capacity of the log buffer 12 when the log information as the storage object is the development control log associated with the priority order “5”. In this case, the priority order “5” (FIG. 3) associated with the development control log is higher than the reference priority order “8” (FIG. 4) associated with the case where the remaining storage capacity is not more than 87.5%, but more than 75% of the storage capacity of the log buffer 12. Thus, the logging controller 15 performs Step S5. That is, the logging controller 15 stores the development control log in the log buffer 12 in association with the current time.

Further, it is, for example, assumed that the log information as the storage object is the emergency log associated with the priority order “1”. In this case, the priority order “1” associated with the emergency log is higher than the reference priority order “2” highest among the reference priority orders associated with the cases where the remaining storage capacity is more than 0%. Thus, if the log information as the storage object is the emergency log, the logging controller 15 performs Step 5 to store the emergency log in the log buffer 12 in association with the current time as long as the remaining storage capacity detected in Step S3 is more than 0%, i.e. there is a little remaining storage capacity.

On the other hand, it is assumed that the priority order associated with the log information as the storage object is not higher than the reference priority order associated with the remaining storage capacity detected in Step S3 (S4; NO). In this case, the logging controller 15 does not perform Step S5, i.e. does not store the log information as the storage object in the log buffer 12. In this case (S4; NO), the processings in and after Step S1 are repeated.

Specifically, it is, for example, assumed that the remaining storage capacity detected in Step S3 is not more than 75%, but more than 62.5% of the storage capacity of the log buffer 12 when the log information as the storage object is the control sequence log associated with the priority order “7”. In this case, the priority order “7” associated with the control sequence log is not higher than the reference priority order “7” associated with the case where the remaining storage capacity is not more than 75%, but more than 62.5% of the storage capacity of the log buffer 12. Thus, the logging controller 15 does not perform Step S5. That is, the control sequence log is not stored in the log buffer 12 and the processings in and after Step S1 are repeated.

If the log information is stored in the log buffer 12 in Step S5, the log transferer 16 performs the transfer process separately from the processings in and after Step S1 repeated thereafter. Specifically, when starting the transfer process, the log transferer 16 successively reads the pieces of the log information stored in the log buffer 12 one by one in a chronological order of the current time associated with the log information (S11) and causes the communication unit 7 to transmit the read log information to the external apparatus (S12). Then, the log transferer 16 deletes the transmitted log information from the log buffer 12 (S13). Thereafter, processings of Steps S11 to S13 are repeated.

As just described, according to this embodiment, the log information corresponding to the priority order(s) higher than the reference priority order corresponding to the remaining storage capacity detected by the remaining amount detector 14 is stored in the log buffer 12 by the logging controller 15. Then, the log information stored in the log buffer 12 is successively transmitted to the external apparatus by the log transferer 16.

For example, due to a high communication load between the external apparatus and the complex machine 1 or the like, the state where the processing speed of the transfer process by the log transferer 16 is lower than that of the logging process by the logging controller 15 continues, whereby the remaining storage capacity may decrease. Even in this case, according to the above embodiment, the log information corresponding to the priority order(s) higher than the reference priority order corresponding to the remaining storage capacity is stored in the log buffer 12 with priority over the log information having the priority order(s) lower than the reference priority order. This reduces a possibility that the log information having a high priority order, i.e. a high importance is not stored in the log buffer 12. As a result, a possibility that the log information having a high importance is not transferred to the external apparatus can be reduced.

Since the priority order of the emergency log, which is the information on abnormalities of each operation unit, is determined to be higher than the highest reference priority order, the emergency log is stored in the log buffer 12 as long as there is a little remaining storage capacity. This reduces a possibility that the emergency log is not transferred to the external apparatus. As a result, it is possible to reduce a possibility that the user operating the external apparatus does not notice the occurrence of an abnormality relating to the operation unit in the complex machine 1.

Note that the configuration and the like shown in FIGS. 1 to 5 are merely an illustration of the embodiment according to the present disclosure and are not intended to limit the present disclosure to this embodiment.

(1) For example, in the above embodiment, eight priority orders are associated with the log information in advance according to the importance of the information expressed by each piece of the log information as shown in FIGS. 3 and 4. Further, eight reference priority orders are so associated with the remaining storage capacities that the higher reference priority order is set as the remaining storage capacity decreases. In the logging process, the logging controller 15 refers to the reference priority order and stores the log information corresponding to the priority order(s) higher than the reference priority order corresponding to the remaining storage capacity detected by the remaining amount detector 14 in the log buffer 12.

However, instead of this, two priority orders including a first priority order and a second priority order lower than the first priority order may be simply associated with the log information according to the importance of the information expressed by the log information. In accordance with this, the logging process may be so simplified that the logging controller 15 stores the log information associated with the first and second priority order in the log buffer 12 if the remaining storage capacity detected by the remaining amount detector 14 is not less than a predetermined reference capacity and stores the log information associated with the first priority order in the log buffer 12 if the remaining storage capacity detected by the remaining amount detector 14 is less than the reference capacity.

Specifically, the emergency log, the system log, the fixing control log, the fixing temperature log, the drum control log and the development control log having a higher importance may be associated with the first priority order (e.g. “1”) and the toner control log, the sheet conveyance control log, the control sequence log and the debug log having a lower importance may be associated with the second priority order (e.g. “2”). 50% of the storage capacity of the log buffer 12 may be determined as the reference capacity.

In accordance with this, the logging controller 15 may determine whether or not the remaining storage capacity detected in Step S3 is not less than 50% of the storage capacity of the log buffer 12 as the reference capacity, instead of Steps S4 and S5. If the remaining storage capacity is determined to be less than 50% of the storage capacity of the log buffer 12 as the reference capacity, the logging controller 15 may store the log information as the storage object in the log buffer 12 when the first priority order is associated with this log information and may not store the log information as the storage object in the log buffer 12 if the second priority order is associated with this log information. On the other hand, if the remaining storage capacity detected in Step S3 is determined to be not less than 50% of the storage capacity of the log buffer 12 as the reference capacity, the logging controller 15 may store the log information as the storage object in the log buffer 12 regardless of which of the first and second priority orders is associated with this log information.

According to this modification, if the remaining storage capacity detected by the remaining amount detector 14 is not less than the reference capacity, the log information assigned with the first and second priority orders is stored in the log buffer 12 by the logging controller 15. On the other hand, if the remaining storage capacity detected by the remaining amount detector 14 is less than the reference capacity, the log information assigned with the first priority order is stored in the log buffer 12 by the logging controller 15. Then, the log information stored in the log buffer 12 is successively transmitted to the external apparatus by the log transferer 16.

For example, due to a high communication load between the external apparatus and the complex machine 1 or the like, the state where the processing speed of the transfer process by the log transferer 16 is lower than that of the logging process continues, whereby the remaining storage capacity may decrease. Even in this case, according to this modification, the log information assigned with the first priority order is stored in the log buffer 12 with priority over the log information assigned with the second priority order lower than the first priority order. This reduces a possibility that the log information having a high priority order, i.e. a high importance is not stored in the log buffer 12. As a result, a possibility that the log information having a high importance is not transferred to the external apparatus can be reduced.

(2) Further, the log information may also be assigned with storage instruction information indicating a need to be stored in the log buffer 12. In accordance with this, the logging controller 15 may store the log information assigned with the storage instruction information in the log buffer 12 if the remaining storage capacity is larger than 0.

For example, during a test operation of the complex machine 1, storage instruction information (e.g. a numerical value of “0”) indicating a need to be stored in the log buffer 12 is assigned to the control sequence log in addition to the priority order “7”. In this case, the logging controller 15 stores the control sequence log in the log buffer 12 in the logging process even if the remaining storage capacity detected by the remaining amount detector 14 is larger than 0 and the reference priority order corresponding to the remaining storage capacity is higher than the priority order “7” of the control sequence log since the storage instruction information is assigned to the control sequence log. This causes the control sequence log to be transmitted from the complex machine 1 to the external apparatus during the test operation of the complex machine 1. As a result, it can be easily confirmed in the external apparatus using the control sequence log transmitted thereto that the complex machine 1 is normally operating.

That is, according to this modification, the information assigned with the storage instruction information out of a plurality of pieces of the log information can be invariably stored in the log buffer 12 regardless of the priority order assigned to this information if the remaining storage capacity is larger than 0 and the information can be stored in the log buffer 12.

Further, besides an application to the above complex machine 1, the electronic apparatus according to the present disclosure can also be applied to image processing apparatus such as scanners, copiers, printers and facsimile machines, game machines, mobile phones and car navigation systems.

According to the present disclosure as described above, it is possible to reduce a possibility that log information having a high importance is not transferred to the external apparatus in the electronic apparatus communicable with the external apparatus.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

1. An electronic apparatus communicable with an external apparatus, comprising:
a communication unit for transmitting information to the external apparatus;
a storage capable of storing information for a predetermined storage capacity;
a logging controller for performing a logging process of storing a plurality of pieces of log information on the electronic apparatus in the storage;
a log transferer for performing a transfer process of causing the communication unit to successively transmit the plurality of pieces of log information stored in the storage to the external apparatus and deleting the transmitted log information from the storage; and
a remaining amount detector for detecting a remaining storage capacity indicating a storage capacity, in which no information is stored, out of the predetermined storage capacity;
wherein:
a first priority order or a second priority order lower than the first priority order is assigned to each of the plurality of pieces of log information according to the importance of the information expressed by each piece of log information; and
in the logging process, the logging controller stores the log information assigned with the first and second priority orders in the storage out of the plurality of pieces of log information if the remaining storage capacity detected by the remaining amount detector is not less than a predetermined reference capacity and stores the log information assigned with the first priority order in the storage out of the plurality of pieces of log information if the remaining storage capacity detected by the remaining amount detector is less than the reference capacity.

2. An electronic apparatus according to claim 1, wherein:
priority orders including the first and second priority orders are respectively assigned to the plurality of pieces of log information according to the importance of the information expressed by each piece of log information; and
in the logging process, the logging controller refers to a reference priority order associated with the remaining storage capacity and predetermined so as to become higher as the remaining storage capacity decreases, and stores the log information corresponding to the priority order higher than the reference priority order corresponding to the remaining storage capacity detected by the remaining amount detector in the storage out of the plurality of pieces of log information.

3. An electronic apparatus according to claim 2, further comprising:
an operation unit for performing a predetermined operation; and
an abnormality detector for detecting an abnormality in the operation of the operation unit;
wherein:
the plurality of pieces of log information include information on the abnormality detected by the abnormality detector; and
the priority order of the log information indicating the information on the abnormality is determined to be higher than the highest reference priority order.

4. An electronic apparatus according to claim 1, wherein:
the plurality of pieces of log information include the log information assigned with storage instruction information indicating a need to be stored in the storage; and
the logging controller stores the log information assigned with the storage instruction information in the storage in the logging process if the remaining storage capacity is larger than 0.

5. A log information transfer method for transferring a plurality of pieces of log information on an electronic apparatus from the electronic apparatus communicable with an external apparatus to the external apparatus, wherein:
the electronic apparatus includes a communication unit for transmitting information to the external apparatus and a storage capable of storing information for a predetermined storage capacity; and
the log information transfer method includes the steps of:
performing a logging process of storing the plurality of pieces of log information in the storage;
performing a transfer process of causing the communication unit to successively transmit the plurality of pieces of log information stored in the storage to the external apparatus and deleting the transmitted log information from the storage; and
detecting a remaining storage capacity indicating a storage capacity, in which no information is stored, out of the predetermined storage capacity;
wherein:
a first priority order or a second priority order lower than the first priority order is assigned to each of the plurality of pieces of log information according to the importance of the information expressed by each piece of log information; and
in the logging process, the log information assigned with the first and second priority orders out of the plurality of pieces of log information is stored in the storage if the detected remaining storage capacity is not less than a predetermined reference capacity and the log information assigned with the first priority order out of the plurality of pieces of log information is stored in the storage if the detected remaining storage capacity is less than the reference capacity.
